(19) United States
(12) Patent Application Publication
(10) Pub. No.: US 2005/0036445 A1
(43) Pub. Date: Feb. 17, 2005

(54) Processing data packets

(76) Inventor: Lee Chien-Hsin, Folsom, CA (US)

Correspondence Address: FISH & RICHARDSON, PC, 12390 EL CAMINO REAL, SAN DIEGO, CA, 92130-2081, US

(21) Appl. No.: 10/642,434

(22) Filed: Aug. 14, 2003

(51) Int. Cl. G08C 15/00

(52) U.S. Cl. 370/229; 370/401

(57) ABSTRACT

A method and system for processing data packets are described. The method receives multiple types of data packets, sends a first predetermined type of the data packets to a first data path and a second predetermined type of the data packets to a second data path, and communicates the types of data packets received to an arbitrator of a shared resource of the data paths. The method also selects how to handle the data packets based on the communicated types of data packets.

### BACKGROUND

Networks enable computers and other devices to exchange data such as e-mail messages, web pages, audio, video, and so forth. To send data across a network, a sending device typically constructs a collection of packets. A receiver can reassemble the data into its original form after receiving the packets.

A packet traveling across a network may make many “hops” to intermediate network devices before reaching its final destination. A packet not only includes data being transported but also includes information used to deliver the packet. This information is often stored in the packet's “payload” and “header(s),” respectively. The header(s) may include information for a number of different communication protocols that define the information that should be stored in a packet. Different protocols may operate at different layers. For example, a low level layer generally known as the “link layer” coordinates transmission of data over physical connections. A higher level layer generally known as the “network layer” handles routing, switching, and other tasks that determine how to move a packet forward through a network.

Many different hardware and software schemes have been developed to handle packets. For example, some designs use software to program a general purpose Central Processing Unit (CPU) processor to process packets. Other designs use components known as application-specific integrated circuits (ASICs), feature dedicated, “hard-wired” approaches and still others use programmable devices known as network processors. Network processors enable software programmers to quickly reprogram network processor operations. Yet, due to their specially designed architectures, network processors can often rival the packet processing speed of an ASIC.

### DESCRIPTION OF DRAWINGS

FIG. 1 is a block diagram of a communication system employing a hardware-based multithreaded processor.

FIG. 2 is a block diagram of a micro engine unit employed in the hardware-based multithreaded processor of FIG. 1.

FIG. 3 is a block diagram depicting a collection of nodes.

FIG. 4 is a block diagram depicting nodes with an IP multicast node.

FIG. 5. is a block diagram depicting the flow of data packets through a network processor.

FIG. 6. is a block diagram depicting the flow of data packets through a network processor with a packet identifier registry.

FIG. 7. are a series of diagrams pictorially depicting the flow of data packets as seen by the arbitrator.

### DETAILED DESCRIPTION

Data packets are received and transmitted by a network processor. Once the network processor receives the data packet, the data packet is stored in a temporary memory location while the data packet is processed and transmitted. The network processor determines the number of ports and number of replications for each port. While in memory the network processor also transmits copies of the data packet out of the determined transmission ports. During periods of high activity, transmission ports become over-congested and cause data packets to sit idle in memory. The memory of the network processor can become limited during periods of over-congestion. These delays and limited memory can cause data packets to be dropped. Dropped data packets can cause serious errors in the transmission of data to downstream points. Delays can also cause the order of packets to become disrupted, which can lead to additional problems at the packet's final destination.

To prevent more important types of packets from being dropped, network processors provide multiple data paths to handle different types of data packets. More important data packets can have streamlined data paths by devoting more of the network processor's resources to handling only that specific type of data packet. However, when the multiple data paths converge on a shared resource, e.g. memory or transmit queue, a bottleneck can still result. By communicating the types of packets about to be received by the shared resource prior to receiving the packets, the shared resource can more efficiently manage the incoming data packets. The shared resource can analyze packets upstream to determine if current packet backlogs can be transmitted at a later time or if data packets must be dropped.

A network processor, in general, can comprise a bus connecting a processor, memory, and a media access controller device. Many network processors also include multiple instruction set processors. Intel's IXP processor® is an example of a network processor with multiple instruction set processors. Intel's IXP processor® is one example of a network processor. Other network processors can have different architectures and take advantage of communicating the type of packet to a shared resource.

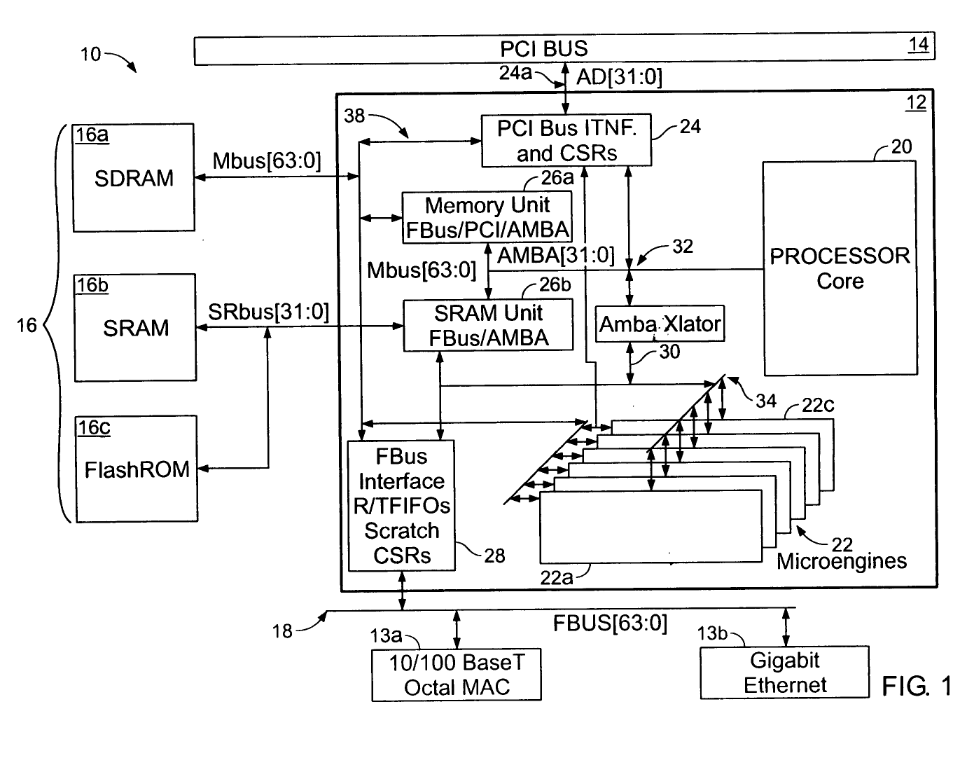

Referring to FIG. 1, a communication system 10 includes a parallel, hardware-based multithreaded processor 12. The hardware-based multithreaded processor 12 is coupled to a bus such as a Peripheral Component Interconnect (PCI) bus 14, a memory system 16 and a second bus 18. The system 10 is especially useful for tasks that can be broken into parallel subtasks. Specifically, the hardware-based multithreaded processor 12 is useful for tasks that are bandwidth oriented rather than latency oriented. The hardware-based multithreaded processor 12 has multiple microengines 22, each with multiple hardware controlled program threads that can be simultaneously active and independently work on a task.

The hardware-based multithreaded processor 12 also includes a central controller 20 that assists in loading microcode control for other resources of the hardware-based multithreaded processor 12 and performs other general purposes, computer-type tasks such as handling protocols, exceptions, and extra support for packet processing where the microengines pass the packets off for more detailed processing such as in boundary conditions. The processor 20 in this example is a Strong Arm® (Arm is a trademark of ARM Limited, United Kingdom) based architecture. The general purpose microprocessor 20 has an operating system. Through the operating system the processor 20 can call functions to operate on microengines 22a-22f. The processor 20 can use a supported operating system, preferably a real-time operating system.

The hardware-based multithreaded processor 12 also includes a plurality of microengines 22a-22f. Microengines 22a-22f each maintain a plurality of program counters in hardware and states associated with the program counters. Effectively, a corresponding plurality of sets of program threads can be simultaneously active on each of the microengines 22a-22f while only one is actually operating at one time.

In this example, there are six microengines 22a-22f, each having capabilities for processing at least four hardware program threads. The six microengines 22a-22f operate with shared resources including memory system 16 and bus interfaces 24 and 28. The memory system 16 includes a Synchronous Dynamic Random Access Memory (SDRAM) controller 26a and a Static Random Access Memory (SRAM) controller 26b. SDRAM memory 16a and SDRAM controller 26a are typically used for processing large volumes of data, e.g., processing of network payloads from network packets. The SRAM controller 26b and SRAM memory 16b are used in a networking implementation for low latency, fast access tasks, e.g., accessing look-up tables, memory for the core processor 20, and so forth.

Hardware context swapping enables other contexts with unique program counters to execute in the same microengine. Hardware context swapping also synchronizes completion of tasks. For example, two program threads could request the same shared resource, e.g., SRAM. When each of these separate units, e.g., the FBUS interface 28, the SRAM controller 26a, and the SDRAM controller 26b, complete a requested task from one of the microengine program thread contexts, they report back a flag signaling completion of an operation. When the flag is received by the microengine, the microengine can determine which program thread to turn on.

As a network processor, the hardware-based multithreaded processor 12 interfaces to network devices such as a media access controller device, e.g., a 10/100BaseT Octal MAC 13a or a Gigabit Ethernet device 13b coupled to communication ports or other physical layer devices. In general, as a network processor, the hardware-based multithreaded processor 12 can interface to different types of communication devices or interfaces that receive/send large amounts of data. The network processor can include a router 10 in a networking application which routes network packets amongst devices 13a, 13b in a parallel manner. With the hardware-based multithreaded processor 12, each network packet can be independently processed. 26.

The processor 12 includes a bus interface 28 that couples the processor to the second bus 18. The bus interface 28 in one embodiment couples the processor 12 to the so-called FBUS 18 (FIFO bus). The FBUS interface 28 is responsible for controlling and interfacing the processor 1b2 to the FBUS 18. The FBUS 18 is a 64-bit wide FIFO bus, used to interface to Media Access Controller (MAC) devices. The processor 12 includes a second interface, e.g., a PCI bus interface, 24 that couples other system components that reside on the PCI 14 bus to the processor 12. The units are coupled to one or more internal buses. The internal buses are dual buses (e.g., one bus for read and one for write). The hardware-based multithreaded processor 12 also is constructed such that the sum of the bandwidths of the internal buses in the processor 12 exceed the bandwidth of external buses coupled to the processor 12. The processor 12 includes an internal core processor bus 32, e.g., an Advanced System Bus (ASB bus) that couples the processor core 20 to the memory controllers 26a, 26b and to an ASB translator 30 described below. The ASB bus is a subset of the so-called AMBA bus that is used with the Strong Arm processor core. The processor 12 also includes a private bus 34 that couples the microengine units to SRAM controller 26b, ASB translator 30 and FBUS interface 28. A memory bus 38 couples the memory controller 26a, 26b to the bus interfaces 24 and 28 and memory system 16 including flashrom 16c used for boot operations and so forth.

Each of the microengines 22a-22f includes an intermediary that examines flags to determine the available program threads to be operated upon. The program thread of the microengines 22a-22f can access the SDRAM controller 26a, SDRAM controller 26b or FBUS interface 28. The SDRAM controller 26a and SDRAM controller 26b each include a plurality of queues to store outstanding memory reference requests. The queues either maintain order of memory references or arrange memory references to optimize memory bandwidth.

Although microengines 22 can use the register set to exchange data, a scratchpad or shared memory is also provided to permit microengines to write data out to the memory for other microengines to read. The scratchpad is coupled to the bus 34.

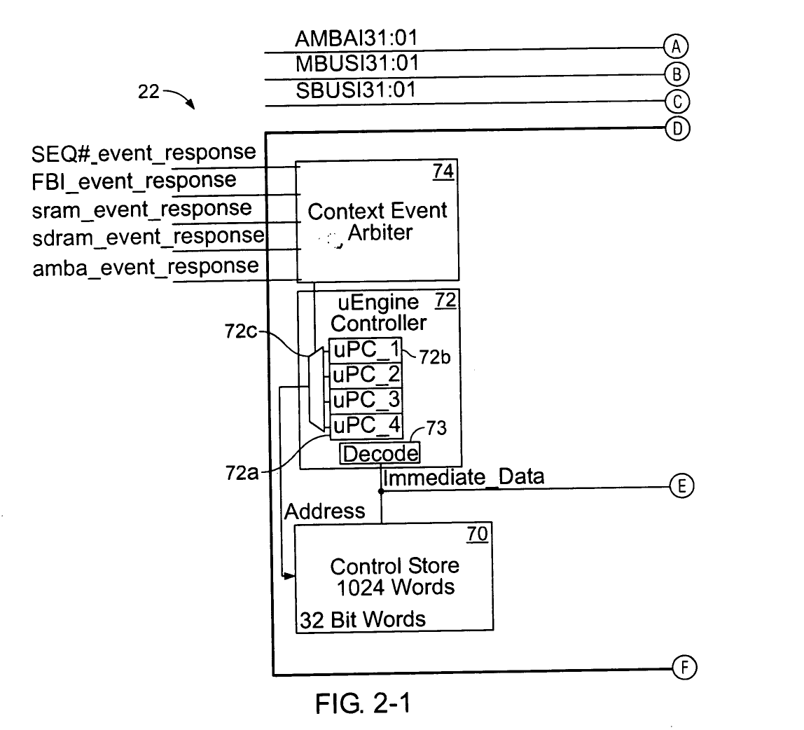

Referring to FIG. 2, an exemplary one of the microengines 22a-22f, e.g., microengine 22f is shown. The microengine includes a control store 70 which, in one implementation, includes a RAM. The RAM stores a microprogram that is loadable by the core processor 20. The microengine 22f also includes controller logic 72. The controller logic includes an instruction decoder 73 and program counter (PC) units 72a-72d. The four micro program counters 72a-72d are maintained in hardware. The microengine 22f also includes context event switching logic 74. Context event logic 74 receives messages (e.g., SEQ_#_EVENT_RESPONSE; FBI_EVENT_RESPONSE; SRAM_EVENT_RESPONSE; SDRAM_EVENT_RESPONSE; and ASB_EVENT_RESPONSE) from each one of the shared resources, e.g., SRAM 26a, SDRAM 26b, or processor core 20, control and status registers, and so forth. These messages provide information on whether a requested task has completed. In addition to event signals that are local to an executing program thread, the microengines 22 employ signaling states that are global. With signaling states, an executing program thread can broadcast a signal state to the microengines 22. The program thread in the microengines can branch on these signaling states. These signaling states can be used to determine availability of a resource or whether a resource is due for servicing.

The context event logic 74 does mediation for the program threads. In one embodiment, the type of mediation is a round robin mechanism. Other techniques could be used including priority queuing or weighted fair queuing. The microengine 22f also includes an execution box (EBOX) data path 76 that includes an arithmetic logic unit 76a and general purpose register set 76b. The arithmetic logic unit 76a performs arithmetic and logic operations as well as shift operations. The registers set 76b has a relatively large number of general purpose registers. In this implementation there are 64 general purpose registers in a first bank, Bank A, and 64 in a second bank, Bank B. The general purpose registers are windowed so that they are relatively and absolutely addressable.

The microengine 22f also includes a write transfer register stack 78 and a read transfer stack 80. These registers are also windowed so that they are relatively and absolutely addressable. The write transfer register stack 78 is where data written to a resource is located. Similarly, the read register stack 80 is for return data from a shared resource. Subsequent to or concurrent with data arrival, an event signal from the respective shared resource, e.g., the SRAM controller 26a, SDRAM controller 26b or core processor, 20 will be provided to context event arbitrator 74 which will then alert the program thread that the data is available or has been sent. Both transfer register banks 78 and 80 are connected to the execution box (EBOX) 76 through a data path. In one implementation, the read transfer register 64 has registers and the write transfer register 64 has registers.

Each microengine 22a-22f supports multi-threaded execution of multiple contexts. One reason for this is to allow one program thread to start executing just after another program thread issues a memory reference and must wait until that reference completes before doing more work. This behavior maintains efficient hardware execution of the microengines because memory latency is significant.

Network processors such as the example described above often handle a variety of protocols to transport data packets. One protocol is to have the network location request data packets directly from an information source, or “sender,” which responds to the request by sending the data packets to the requesting location. This method of sending data packets from a single point, such as the sender, to a single point, such as the user, is often referred to as unicast transmission.

A drawback of unicast transmission is that the packet travels on one path to the final destination. This increases the chances that a disruption in the path of the packet will result in the packet not reaching its final destination. In addition, the packet may take a path that is not the most direct to the final destination. Since a router at a node may not be aware of an overall quicker route the packet may be sent to a node that is further away from the packet's final destination. In addition, the router can only send one replication of the packet out of one port. Therefore, even though the router may have two possible routes, the router must select one to transmit the packet.

An alternative to unicast transmission allows data packets to be sent from a single point to multiple branch points to the final point. This method of sending information, called layer 2 multicast transmission, is a more efficient way of transmitting data packets in a network. The network has a number of multicast capable routers and the information enters the network as a single data packet from a source to a multicast router. As the data packet travels through the network, multicast capable routers replicate the data packet and send the information to downstream routers.

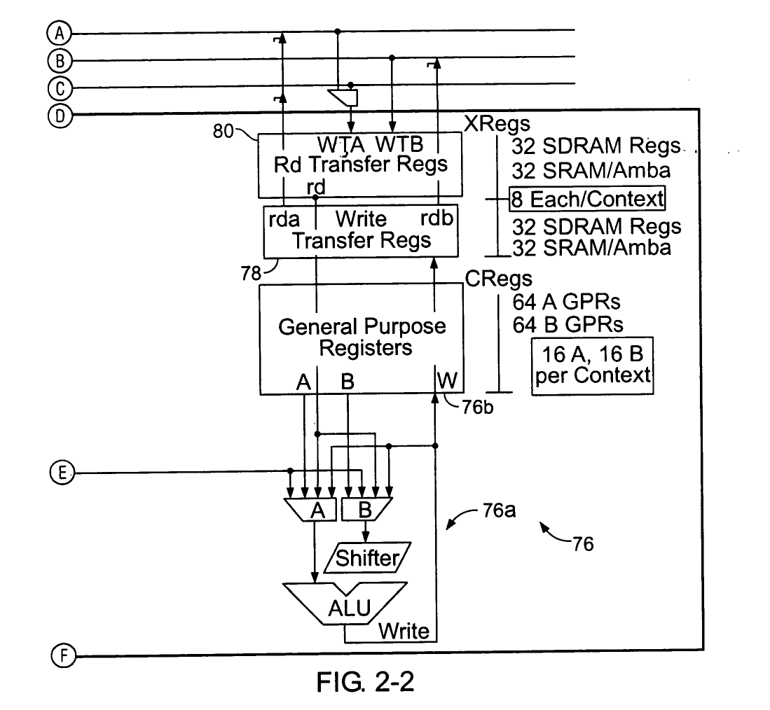

Referring to FIG. 3, the router at node 2 would receive a data packet from node 1 and then replicate the data packet and send data packets to nodes 3, 4, and 5. The router at node 3 would receive the data packet and replicate the data packet and send data packets to nodes 4, 6, and 7. Thus, while only one data packet was transmitted from node 1, four data packets were received at the final destinations nodes 4, 5, 6, and 7. The multicast transmission allows the source to transmit one data packet, making efficient use of the source bandwidth while transmitting the data packet to four final destinations.

To perform layer 2 multicast, a server, router or switch first receives the data packet. The server then determines which locations downstream should receive the data packet. The server does this by processing the packet header to determine the packet's final destinations. The server then uses a routing table stored in the server's memory to determine the next possible upstream hops to advance the data packet to its final destination. The server sends the data packet to the next set of hops. This can involve multiple destinations requiring the server to make multiple replications of the data packet. For example, the server at node 2 in FIG. 3 would have to make three replications of the data packet. One replication would be sent to node 3, another replication would be sent to node 4, and a last replication would be sent to node 5. This involves a replication for each transmission.

A difficulty with layer 2 multicasting is that it produces excess traffic on the network. In the example shown in FIG. 3, the packet is sent to node 7 via nodes 3 and 4. While this produces only one extra packet in the simple example, on a large-scale network layer 2 multicasting produces a large excess of packets that congest the network and cause packet delays and forces packets to be dropped. IP multicasting is a networking technology that aims to deliver information to multiple destination nodes while minimizing the traffic carried across the intermediate networks. To achieve this, instead of delivering a different copy of each packet from a source to each end-station, packets are delivered to special IP multicast addresses that represent the group of destination stations and intermediate nodes that take care of producing extra copies of the packets on outgoing ports as needed.

A characteristic that distinguishes IP Multicast packets from layer 2 packets (Ethernet for instance) is that on layer 2 multicasting only one copy of the packet needs to be delivered to each outgoing port per input packet, whereas for IP Multicasting multiple copies of a single packet may need to be delivered on a given outgoing port, e.g. a different copy needs to be sent on each virtual local area network (VLAN) where at least one member of the multicast group is present on that port. For example, if ten customers sign-up for a video broadcast program and each of them is in a different VLAN but the ten VLANS are all co-existing and reachable through the same output port, 10 distinct copies of the packet will be sent on that port.

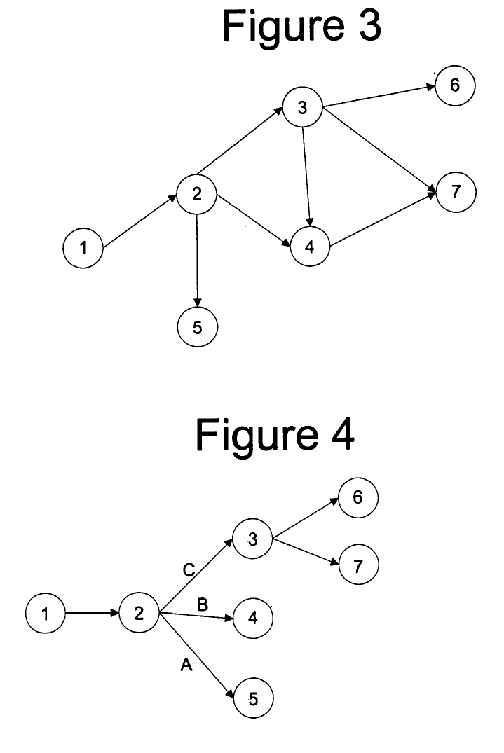

Referring now to FIG. 4, the original example has node 2 being an IP multicast server with an IP multicast address. The IP multicast server transmits one replication of the data packet out of port A to node 5 and one replication of the data packet out of port B to node 4. In addition, the IP multicast router also transmits two replications out of port C. One of these replications is destined for node 6 and the other replication is destined for node 7. While IP multicasting more efficiently distributes packets across the network, it also increases demands on servers at the intermediate nodes.

With unicast transmission, a server receives the data packet and stores the data packet in memory. The server processes the header of the data packet to determine the next destination to transmit the data packet. The server replicates the data packet and transmits it. Since the server only replicates and transmits the packet once, the server is now ready to handle the next data packet. The server receives the next data packet and stores it in the same memory as the previously transmitted data packet. The server processes and transmits the data packet.

However, this method of processing packets by a server can become inefficient when multicast packets require multiple replications. The time required to replicate a packet can often diverge from the time required to transmit the data packet. One way of dealing with this issue is to have multiple memory locations. This allows the server to continually receive data packets and process data packets while previous data packets are replicated and transmitted. However, without a sufficiently large memory there exists the potential that replication bottleneck will cause a memory location to be written over prior to completion of all replications.

IP multicasting compounds the inefficiency. Not only are replications made to send down multiple ports but also multiple replications may need to be sent out of each port. The time period to replicate the packet, delays due to transmitting to multiple ports, and delays due to transmitting multiple packets on the same port can produce a backlog of packets that have been received and stored but that are not finished replicating and transmitting. Even with sufficiently large memory there is still the possibility of writing over a packet in memory prior to completion of all replications and transmission.

Network processors typically handle a variety of data packets types and protocols. To more efficiently use the network processors resources, network processors typically provide specialized data paths based on the type of data packet or transport protocols. In the network processor example described above, some microengines can be designated and structured to handle certain types of data packets. The network processor will then only route that specific type of data packet to those microengines specializing in that type of data packet. Increasing the number of microengines assigned to service a particular type of data packet shortens the processing time for that type of data packet, thus decreasing the chances that the packet will be dropped or delayed.

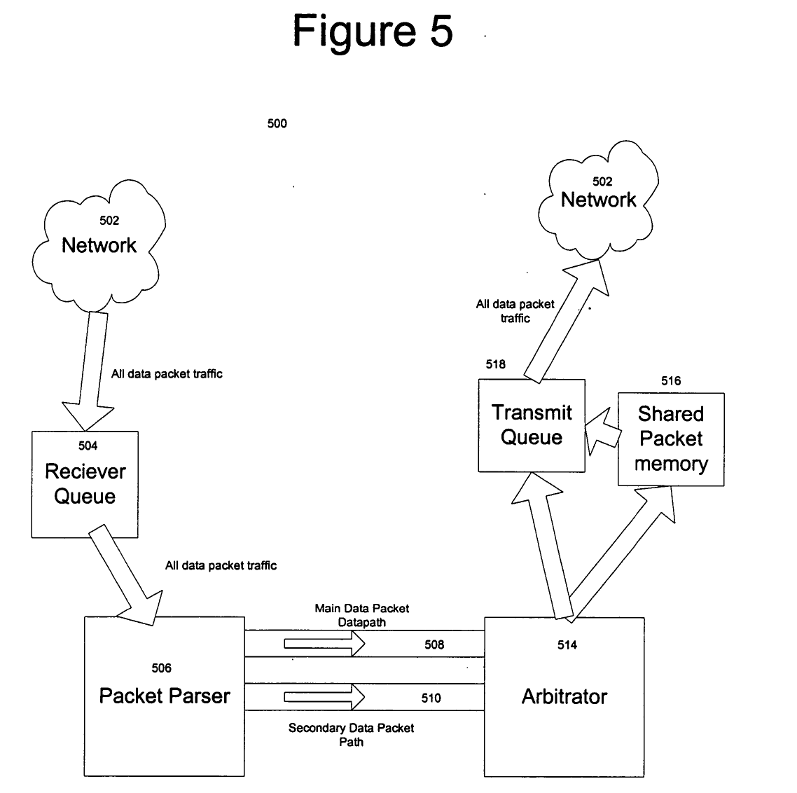

Referring to FIG. 5, a network processor processes data packets 500. The data packets are received into a receiver queue 504 from a network 502. A packet parser 506 identifies the types of data packets and directs each data packet to the correct data path based on the type of data packet. To more efficiently use the network server's resources, network servers typically provide specialized data paths based on the type of data packet or transport protocols. The data packets in this example have two possible data paths: the main data packet data path 508 or a secondary data packet data path 510. A main data path 508 handles general packet processing while a secondary data path 510 specializes in handling specific data packets. An example of a packet data path is receiving a packet and processing the packet header with microengines to identify the transmission port based on the packets next hop or final destination. This can include updating the packet header based on the next destination.

A variety of types of data packets can be directed to different data path. For example, it may be more important to ensure IP multicast data packets are processed and not dropped. Three microengines can be assigned to handle only IP multicast packets on the secondary data path 510 while three other microengines handle all other types of data packets on the main data path 508. This increases the chances that the IP multicast packet will not be delayed due to a backlog of non-IP multicast packets.

Other examples of types of packets that can be directed to a secondary data path are video and audio data packets. Types of packet where packet order or preventing dropped packets is a priority can be routed to a specialized, separate path. The number of data path is also not limited to main and secondary data paths. The network processor can have three or more separate data paths to handle the data packet traffic. For example, audio data packets can be routed to a third data path (not shown) and video data packets can be routed to a fourth data path (not shown).

Even with the separate data paths, when the main 508 and secondary 510 data paths converge on a common resource, e.g. memory 516 or transmit queue 518, a bottleneck can still result. To handle the bottleneck produced by the two paths converging an arbitrator 514 implements schemes to prioritize data packets' utilization of the shared resources during peak periods. The arbitrator 514 determines whether to send the received data packets to a transmit queue 518 or to memory 516 or to drop the data packet. The transmit queue 518 sends the processed data packets back to the network 502. The memory 516 stores the processed packet for further processing or to wait for availability in the transmit queue 518.

Complex schemes have been developed to maintain packet order while providing priority to certain types of packets. Based on the current flow of packets the complexity increases to try to predict the future flow based on the current or past flow. This is because the arbitrator 514 can only see the packets as they are received from the data paths. The arbitrator 514 may currently be dealing with a flood of data packets but may have no way to determine how long the flood of data packets will continue. The arbitrator 514 also has no way to determine if a future period of reduced packet flow can be used to reduce a current congestions of data packet. This results in a greater complexity of schemes to handle a variety of unexpected packet flows.

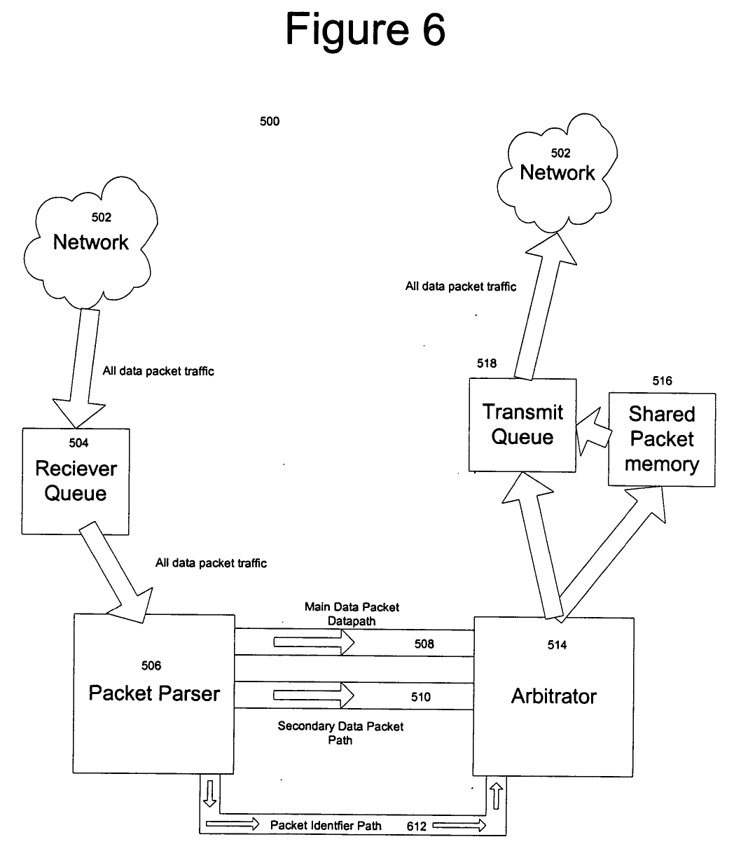

Referring to FIG. 6, a packet identifier path 602 is used to communicate the types of packets the arbitrator will be receiving. The packet identifier path 602 can be implemented with a shift registry or memory array. The packet parser 506 identifies the type of packet received by examining the packet header of each data packet. The packet parser 506 routes the data packet to the specific data path based on the type of packet. The packet parser 506 also communicates the type of packet as each packet arrives via the packet identifier path 612 to the arbitrator 514. The arbitrator 514 determines how to handle the packets. Seeing the packet before they arrive allows the arbitrator to better handle packets as they are received and simplifies how the arbitrator 514 handles the packets.

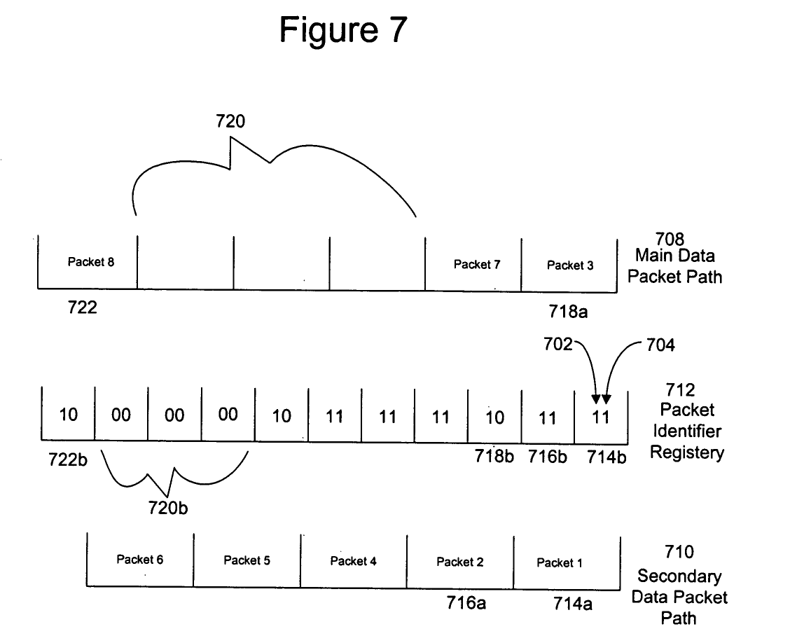

Referring to FIG. 7, the packet identifier path 712 can be a two-bit wide shift registry. The first bit 702 of a slot in the registry communicates that a packet was received. The second bit 704 of the slot in the registry communicates the type of packet received. Each clock-cycle the shift registry moves the two-bit wide slot to the right. The right-most slot 714b which houses information on the oldest received slot is dropped. The left-most slot 722b is set to communicate the next packet received. In the example shown in FIG. 7, the first packet 714a received is an IP multicast packet. The packet is routed down the secondary data path 710. The “11” in the first slot 714b of the shift registry indicates that a packet was received and that it was routed to the secondary data packet path 710. The second packet 716a was received and routed down the secondary data path 710. Again the “11” in the second slot 716b indicates that the second packet was received and routed to the secondary data packet path 710. The third packet 718a is a non-IP multicast packet. The packet is received and routed down the main data packet path 708. The “10” in the third slot 718b of the registry indicates that the packet was received and that it was routed down the main data packet path.

After receiving the seventh packet, the packet parser goes through a period of 3 cycles where a packet is not received. The “00” in the three slots of 720b indicate that no packet had been received. The arbitrator can use this information to handle current packet congestion. In the example shown in FIG. 7, the arbitrator is about to receive a combination of seven packets from the main 708 and secondary paths 710. Without seeing the empty stages 720 in the main data packet path 708 the arbitrator may choose to drop the packets. However, the packet identifier path 712 allows the arbitrator to identify future packet flows. The arbitrator can take advantage of the reduced flow, e.g. empty stages 720, to handle the current overflow of packets. For example, the arbitrator can choose to store the overflow of packets in memory and then transmit the overflow packets during periods of identified reduce transmissions of packets. In another example, the arbitrator can determine what types of packets to store and how long to store them before being forced to drop the packet.

1. A method for processing data packets comprising:
receiving multiple types of data packets,
sending a first predetermined type of data packet to a first data path and a second predetermined type of data packet to a second data path, and
communicating in advance the types of data packets received to an arbitrator of a shared resource of the data paths.

2. The method of claim 1, further comprising:
selecting how to handle the data packets based on the communicated types of data packets.

3. The method of claim 1, further comprising:
selecting data packets for a shared resource of the data paths based on the communicated types of data packets.

4. The method of claim 1, further comprising:
selecting a shared resource to send a data packet based on the communicated types of data packets.

5. The method of claim 1 wherein sending further comprises sending a third predetermined type of data packet to a third data path.

6. The method of claim 1 wherein communicating further comprises communicating the order that the data packets were received.

7. The method of claim 1 wherein the first predetermined type of data packets are non-IP multicast packets and the second predetermined type of data packets are IP multicast packets.

8. A computer program product, disposed on a computer readable medium, for processing data packets comprising instructions for causing a processor to:
receive multiple types of data packets,
send a first predetermined type of data packet to a first data path and a second predetermined type of data packet to a second data path, and
communicate in advance the types of data packets received to an arbitrator of a shared resource of the data paths.

9. The program of claim 8 further comprises instruction for causing a processor to:
select how to handle the data packets based on the communicated types of data packets.

10. The program of claim 8 further comprises instruction for causing a processor to:
select data packets for a shared resource of the data paths based on the communicated types of data packets.

11. The program of claim 8 further comprises instruction for causing a processor to:
select a shared resource to send a data packet based on the communicated types of data packets.

12. The program of claim 8 further comprises instruction for causing a processor to:
send a third predetermined type of data packet to a third data path.

13. The program of claim 8 further comprises instruction for causing a processor to:
communicate further comprises communicating the order that the data packets were received.

14. The program of claim 8 wherein the first predetermined type of data packets are non-IP multicast packets and the second predetermined type of data packets are IP multicast packets.

15. A system for processing a data packet, the system comprising:
at least one communication port;
at least one Ethernet MAC (Medium Access Control) device coupled to at least one of the at least one communication ports;
at least one processor having access to at least one Ethernet MAC device; and instructions for causing at least one processor to:
receive multiple types of data packets,
send a first predetermined type of data packet to a first data path and a second predetermined type of data packet to a second data path, and
communicate in advance the types of data packets received to an arbitrator of a shared resource of the data paths.

16. The system of claim 15 further comprises instruction for causing at least one processor to:
select how to handle the data packets based on the communicated types of data packets.

17. The system of claim 15 further comprises instruction for causing at least one processor to:
select data packets for a shared resource of the data paths based on the communicated types of data packets.

18. The system of claim 15 further comprises instruction for causing at least one processor to:
select a shared resource to send a data packet based on the communicated types of data packets.

19. The system of claim 15 further comprises instruction for causing at least one processor to:
send a third predetermined type of data packet to a third data path.

20. The system of claim 15 further comprises instruction for causing at least one processor to:
communicate further comprises communicating the order that the data packets were received.

21. The system of claim 15 wherein the first predetermined type of data packets are non-IP multicast packets and the second predetermined type of data packets are IP multicast packets.

22. A device for processing data packets comprising:
a module to receive multiple types of data packets,
a module to send a first predetermined type of data packet to a first data path and a second predetermined type of data packet to a second data path, and
a module to communicate in advance the types of data packets received to an arbitrator of a shared resource of the data paths.

23. The device of claim 22 further comprises:
a module to select how to handle the data packets based on the communicated types of data packets.

24. The device of claim 22 further comprises:
a module to select data packets for a shared resource of the data paths based on the communicated types of data packets.

25. The device of claim 22 further comprises:
a module to select a shared resource to send a data packet based on the communicated types of data packets.

26. The device of claim 22 further comprises:
a module to send a third predetermined type of data packet to a third data path.

27. The device of claim 22 wherein the module to communicate further comprises: communicating the order that the data packets were received.

28. The device of claim 22 wherein the first predetermined type of data packets are non-IP multicast packets and the second predetermined type of data packets are IP multicast packets.
